(19) United States
(12) Patent Application Publication
(10) Pub. No.: US 2012/0048000 A1
(43) Pub. Date: Mar. 1, 2012

(54) METHOD AND SYSTEM TO DETECT AND MEASURE PIPING FUEL LEAK

(76) Inventor: Joseph KIRZHNER, Greenville, SC (US)

(21) Appl. No.: 12/872,274

(22) Filed: Aug. 31, 2010

(51) Int. Cl. G01M 3/28

(52) U.S. Cl. 73/40.5 R

(57) ABSTRACT

The described method and system utilize continuous and/or periodic measurement of the fuel pipes to detect leakage of fuel. In general, the piping is enclosed in an air-tight containment cover so that a passage is formed between the piping and containment cover. Measurements can be conducted, using known hydrocarbon and other combustible gases industrial analyzers, and leak detectors. Pressure drop within the passage can be compensated by controlling of air inlet flow into the passage, coordinated with the analyzer pumping rate. Temperature and motion of a gas sample can be controlled by heating the inlet air. The system can includes the controlling valves for the leak source localization. The described method and system can be used to analyze and control fuel leak for late lean injection system for combustor of a turbine.

One or more aspects of the present invention relate to method and system for continuous and/or periodic measurements of fuel pipes to detect leaks. The method and system are also useful to detect leaks in late lean injection arrangement in combustors of turbines.

### BACKGROUND OF THE INVENTION

Fuel piping leaks could lead to fire, explosion and to environment contaminations. Also with increasing fuel prices along with diminishing sources of hydrocarbons, fuel piping leakage monitoring has become more important. In addition, there is a growing interest in flexible fuels, i.e. using a wide range of fuels, for gas turbine applications. Flexible fuels require wider temperature ranges to meet delivery and combustion requirements. However, wider temperature ranges usually lead to higher thermal stress levels, and thus increases the probability of leakage.

Some conventional methods to deal with leakage suggest testing for hydrocarbons leakage by building a sealed housing evaporative determination (SHED) apparatus. See e.g., U.S. Pat. No. 7,043,963. Other conventional methods suggest using tight enclosures around a specific narrow location of possible sources of the leakage. See e.g., U.S. Pat. Nos. 5,343,191 4,206,402, 4,981,652, 5,753,185, 5,377,528, and 5,594,162. For example, FIGS. 9 and 10 illustrate such a scenario. As seen, the fuel is carried in within an interior of a fuel pipe 1 which is tightly enclosed by an insulation material 2 such as a rug. A local leak can be detected by a sensor 3. An example of such a sensor is a proximity capacity switch, which detects leaks by detecting changes in dielectric constants caused by the leaking fuel.

Unfortunately, the conventional methods fail to address the problem of detecting leakage in relatively long fuel piping. The conventional methods also fail to address detecting leakage in piping components for gas turbines with late lean injection (LLI) piping.

### BRIEF SUMMARY OF THE INVENTION

A non-limiting aspect of the present invention relates to a system for detecting leaks in a fuel delivery arrangement. The system can include a fuel pipe, a containment cover surrounding the fuel pipe along at least a length portion of the fuel pipe so as to define a passage between an outer surface of the fuel pipe and an inner surface of the containment cover, a plurality of sampling valves distributed in a length direction along the containment cover such that inlets of the sampling valves are fluidly connected to the passage, a gas detector fluidly connected to outlets of the sampling valves and arranged to analyze gas sampled by one or more of the plurality of sampling valves, and a controller arranged to determine whether or not there is a fuel leak based on signals from the gas detector.

Another non-limiting aspect of the present invention relates to a system for detecting leaks in a fuel delivery arrangement. The system can include a combustor in which fuel and air mixture is combusted, an enclosure surrounding the combustor along at least portion of the combustor so as to define a dilution chamber in which compressed air from a compressor is provided, a plurality of LLI fuel pipes fluidly connected to the combustor and arranged to deliver fuel to be injected into the combustor, a plurality of local LLI sampling valves whose inlets are each fluidly connected to a portion of the dilution chamber substantially co-located where the corresponding LLI fuel pipe fluidly connects with the combustor, a gas detector fluidly connected to outlets of the sampling valves and arranged to analyze gas sampled by one or more of the sampling valves, and a controller arranged to determine whether or not there is a fuel leak based on signals from the gas detector.

The invention will now be described in greater detail in connection with the drawings identified below.

### BRIEF DESCRIPTION OF THE DRAWINGS

These and other features of the present invention will be better understood through the following detailed description of example embodiments in conjunction with the accompanying drawings, in which:

FIG. 1 illustrates an embodiment of a fuel pipe set up for detecting piping leakage according to a non-limiting aspect of the present invention;

FIG. 2 illustrates an example axial view of the fuel pipe embodiment of FIG. 1;

FIG. 3 illustrates an embodiment of a system for detecting piping leakage according to a non-limiting aspect of the present invention;

FIG. 4 illustrates a more detailed embodiment of a fuel pipe set up for detecting piping leakage according to a non-limiting aspect of the present invention;

FIG. 5 illustrates another embodiment of a fuel pipe set up for detecting piping leakage according to a non-limiting aspect of the present invention;

FIG. 6 illustrates an of a set up for detecting leakage in a late lean injection arrangement according to a non-limiting aspect of the present invention;

FIG. 7 illustrates an example axial view of the late lean injection arrangement of FIG. 6;

FIG. 8 illustrates another example axial view of the late lean injection arrangement of FIG. 6; and

FIGS. 9 and 10 illustrate a conventional fuel pipe set up for detecting piping leakage.

### DETAILED DESCRIPTION OF THE INVENTION

Novel method and system for measuring and detecting fuel piping leaks are described. The described method and system utilize continuous and/or periodic measurement of the fuel pipes to detect leakage of fuels such as liquid and/or gas hydrocarbons, hydrogen, and oxides of carbon. In general, the fuel piping is enclosed in an air-tight containment structure so that a passage is formed by the fuel piping and the containment structure. Measurements can be conducted, using known hydrocarbon and other combustible gases industrial analyzers, and leak detectors. Pressure drop within the passage can be compensated by controlling of air inlet flow into the passage, coordinated with the analyzer pumping rate. Temperature and motion of the gas sample can be controlled by heating the inlet air. The system can include the controlling valves for the leak source localization.

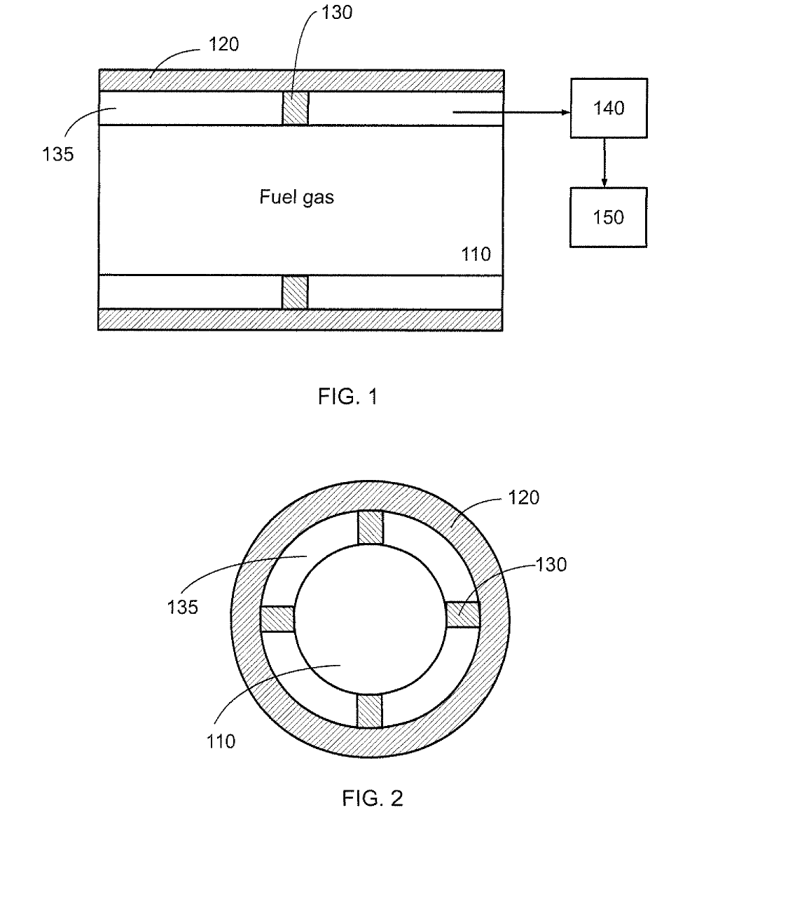

FIG. 1 illustrates an embodiment of a fuel pipe set up for detecting a fuel piping leakage according to a non-limiting aspect of the present invention and FIG. 2 illustrates an example axial view of the same fuel pipe embodiment. In FIG. 1, only a small length portion of the fuel pipe set up is illustrated for explanation purposes. In practice, the fuel pipe 110 can be lengthy.

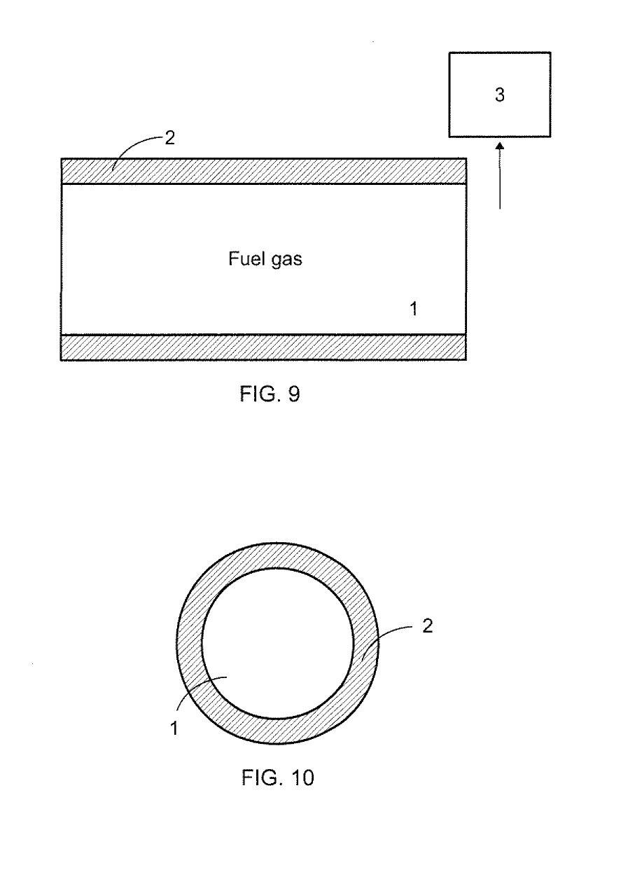

In the illustrated fuel pipe setup, the fuel is carried in within the interior of a fuel pipe 110. Unlike the conventional fuel pipe setup illustrated in FIGS. 9 and 10, the fuel pipe 110 is not tightly enclosed by an insulation material. Rather, a plurality of spacers 130 are distributed on the outer surface of the fuel pipe 110 along at least a length portion of the fuel pipe 110. Preferably, the spacers 130 are distributed along the entire length of the fuel pipe 110. A containment cover 120 is placed on the plurality of spacers 130. The containment cover 120 surrounds the fuel pipe 110 along the length portion of the fuel pipe 110 so as to define a passage 135 between the outer surface of the fuel pipe 110 and the inner surface of the containment cover 120. The containment cover 120 is sufficiently air tight such that any fuel that leaks from the fuel pipe 110 to the passage 135 is substantially contained within the passage 135. In this way, dilution of the leaked fuel in the passage 135 is minimized, which in turn increases the likelihood of leak detection.

The size and/or shape of the spacers 130 are not particularly limited. The only requirement is that the spacers 130 be of sufficient strength and rigidity so that the passage 135 is defined when the containment cover 120 is placed on the spacers 130. As seen in FIG. 2, the spacers 130 should allow the gas to flow within the passage 135. One main purpose of the spacers 130 is to provide support to the containment cover 120 so that the passage 135 can be defined between the fuel pipe 110 and the containment cover 120. In that sense, the spacers 130 are not strictly necessary as long as the passage 135 can be defined. As an example, the containment cover 120 itself may provide the necessary structural support.

A fuel leak from the pipe 110 within this portion of the passage 135 can be detected through a combination of a gas detector 140 and a controller 150. In one non-limiting aspect, the gas detector 140 analyzes the gas flowing within the passage 135 and sends signals to the controller 150. Examples of the gas detector 140 include a gas analyzer (e.g. HC gas analyzer), spectrometer, and a lower explosion limit (LEL) sensor. Based on the signals from the gas detector 140, the controller 150 determines whether or not there is a fuel leak.

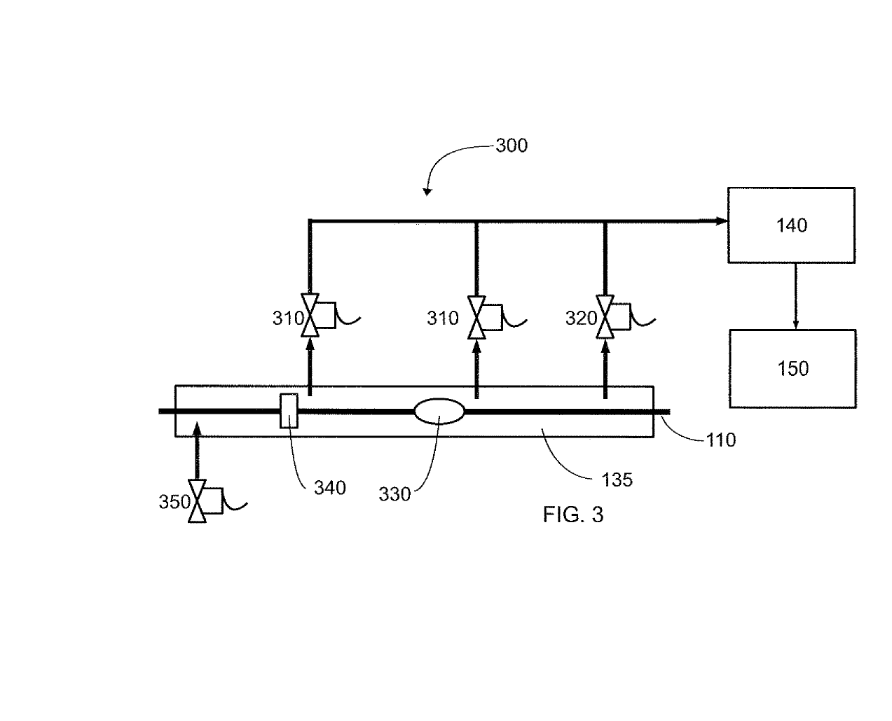

FIG. 3 illustrates an embodiment of a system 300 for detecting piping leakage according to a non-limiting aspect of the present invention. The system 300 includes the fuel pipe setup of FIGS. 1 and 2. For simplicity, only the fuel pipe 110 and the passage 135 are specified. But one of ordinary skill would understand that the system 300 also includes the necessary means, e.g. the containment cover 120 and perhaps the spacers 130, to define the passage 135. In addition, the fuel pipe 110 is shown to be straight in FIG. 3. However, one of ordinary skill would understand that the fuel pipe 110, along with the passage 135, can be bent in many directions. The description with regard to FIG. 3 is fully applicable to a system in which the fuel pipe 110 includes multiple bends.

It should be noted that the fuel pipe 110 itself can carry liquid or gaseous fuels. A non-exhaustive list of fuels includes hydrocarbons, hydrogen and oxides of carbon. But in a non-limiting aspect of the present invention, when the fuel leaks from the fuel pipe 110 into the passage 135, the gaseous form of the fuel in the passage 135 is detected.

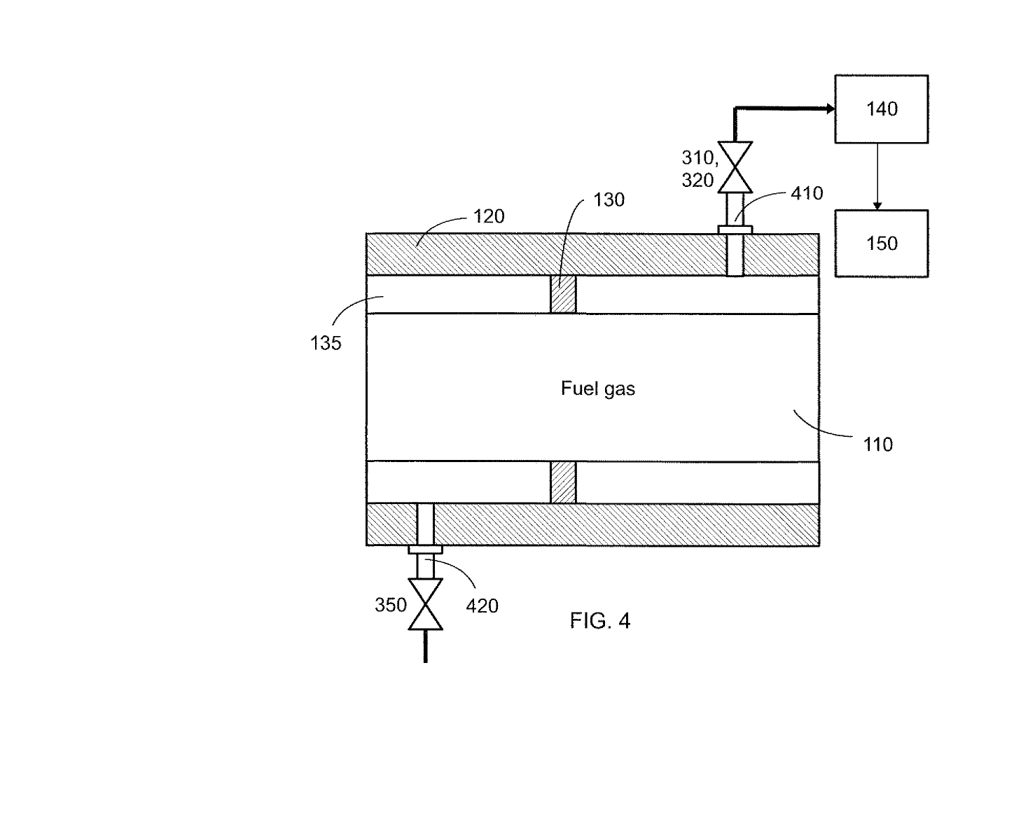

As seen, the system 300 includes a plurality of sampling valves 310, 320 distributed in a length direction along the passage 135. The inlets of the sampling valves 310, 320 are fluidly connected to the passage 135. FIG. 4 illustrates a more detailed view of the fuel pipe set up. As seen, the fluid connection between the passage 135 and the sampling valve 310, 320 can be provided through sampling pipes 410. Also the fluid connection between the passage 135 and the air supply valves 350 can be provided through air supply pipes 420. The system 300 also includes the gas detector 140 fluidly connected to the outlets of the sampling valves 310, 320 to analyze the gas sampled by the sampling valves 310, 320, and to send appropriate signals to the controller 150 as described above with respect to FIG. 1.

Referring back to FIG. 3, it is assumed that the gas within the passage 135 is encouraged to flow in one direction length wise, from left to right. Thus, the left and right ends of the passage 135 are respectively the upstream and downstream ends. For example, some or all sampling valves 310, 320 may include a pump to actively move the gas from the inlet to the outlet thereof. As another example, one or more pumps (not shown) may be separately provided.

To facilitate the flow of gas in the passage 135 in the preferred direction, an air supply valve 350 whose outlet is fluidly connected to the passage 135 may be provided. While only one air supply valve 350 is shown in FIG. 3, this is not a limitation. Multiple air supply valves 350 may be distributed along the length of the passage 135. Indeed, when the length of the passage 135 is long, multiple air supply valves 350 may be preferable. Preferably, at least one at least one air supply valve 350 is fluidly connected to the passage 135 upstream of all sampling valves 310, 320. One way to accomplish this is to fluidly connect at least one air supply valve 350 substantially at the upstream end of the passage 135.

In FIG. 3, one sampling valve 320 is downstream of all other sampling valves 310. The sampling valve 320 may be referred to as a global sampling valve 320 and each sampling valve 310 may be referred to as a local sampling valve 310. Preferably, the global sampling valve 320 is fluidly connected to the passage 135 substantially at the downstream end thereof. With this arrangement, it is possible to detect a fuel leak anywhere along the entire length portion of the fuel pipe 110 by sampling the gas through the global sampling valve 320. If the fuel leak is detected, then the leak location may be localized by sampling the gas through individual local sampling valves 310.

The fuel pipe 110 in many cases will likely be formed by connecting multiple pipe sections connected to each other through pipe couplers (not shown). There are many ways the pipe sections may be connected each other such as through weldings, flanges, connectors (e.g. T, cross, 3-way, 4-way) and fittings (90° elbows, 45° elbows). In FIG. 3, a pipe welding 330 and a flange 340 are illustrated as example pipe couplers.

Note that for each pipe coupler 330, 340, there is a corresponding local sampling valves 310 whose inlet is fluidly connected to the portion of the passage 135 substantially co-located to the pipe coupler 330, 340. This is because leaks are more likely to occur at these coupling points. Preferably, the inlet of the local sampling valve 310 is fluidly connected to the passage immediately downstream of the pipe coupler 330, 340.

Of course, it is not necessary for each pipe coupler 330, 340 to have a corresponding local sampling valve 310. For example, multiple pipe couplers 330, 340 may be located relatively close to each other. In this instance, co-locating one local sampling valve 310 immediately downstream of the last of the closely located pipe couplers 330, 340 may be sufficient.

Conversely, it is also not necessary that each local sampling valve 310 to have a corresponding pipe coupler 330, 340. That is, multiple local sampling valves 310 may be distributed along a particular pipe section (not shown) such that the fuel leak location may be localized to a finer degree. For example, a relatively long pipe section may be buried under ground. If a leak within the pipe section can be localized, then the excavation activities to access the source of the leak for repairs can be minimized.

Preferably, the operations of the sampling valves 310, 320 are controllable by the controller 150. The sampling valves 310, 320 maybe controlled individually. Also preferably, the operations of the air supply valves 350 are individually controllable by the controller 150.

In one example method of detecting a fuel leak, the controller 150 together with the gas detector 140 can monitor the gas in the passage 135—continuously or periodically—by sampling the gas through the global gas sampling valve 320. If the fuel leak is detected, then the location of the leak may be localized by operating the local sampling valves 310 appropriately. Another method is to monitor the gas globally by opening all gas sampling valves 310, 320. When the leak is detected, the leak can be localized by closing the sampling valves 310, 320 one or a few at a time. Of course, a mixture of these methods is also possible. To ensure that the leak is properly localized regardless of the method, the controller 150 can maintain proper gas flow direction within the passage 135 by operating the air supply valves 150 and any pumps.

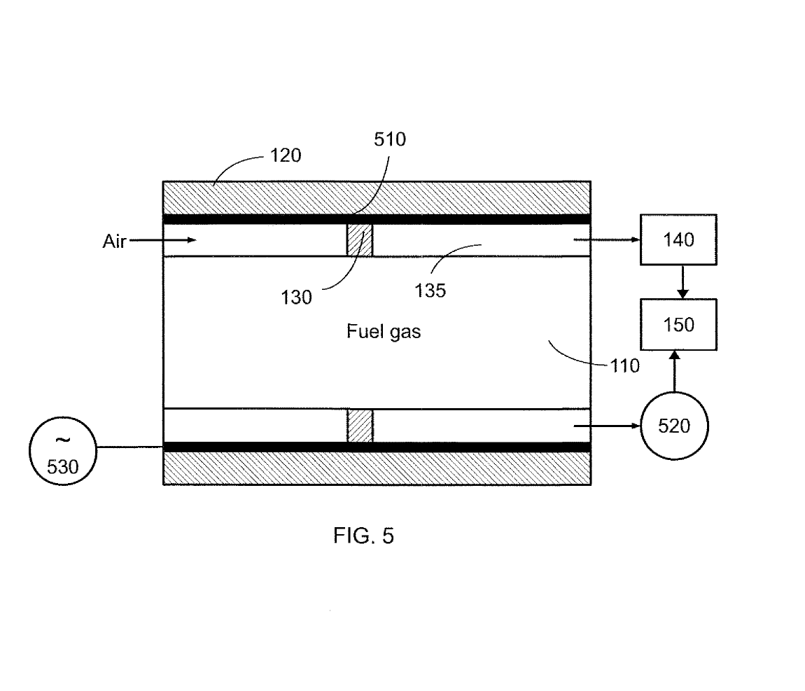

FIG. 5 illustrates another embodiment of a fuel pipe set up for detecting fuel piping leakage according to a non-limiting aspect of the present invention. This embodiment allows more reliable detection than the basic embodiment of FIG. 1. The embodiment in FIG. 5 also includes the fuel pipe 110, the containment cover 120, the spacers 130, the gas detector 140 and the controller 150. FIG. 5 embodiment further includes a heater 510 and a pressure gauge 520. Heat to the heater 510 can be provided by the heat energy source 530.

The controller 150 can maintain the passage 135 at a desired gas pressure by monitoring the gas pressure via the pressure gauge 520 and operating the sampling valves 310, 320, the air supply valves 350, and/or any forced pumps accordingly. The controller 150 can also maintain the passage 135 at a desired temperature by operating the heater 510, e.g. by controlling an amount of energy supplied by the heat energy source 530. For example, it is preferable that the temperature in the passage 135 be high enough such that condensation of any leaked fuel is sufficiently prevented from occurring. Preferably, the containment cover 120 should be of sufficient thermal insulation so that the amount of energy consumed by the heater 510 is minimized.

In FIG. 5, the heater 510 is located on the inner surface of the containment cover 120. But this is not a requirement. When present, it is only necessary that the heater 510 be located so as to heat the passage 135. For example, the heater 510 may be located on the outer surface of the fuel pipe 110 (not shown). Indeed, the spacers 130 may themselves serve a double duty as the heaters. Further, the shape of the heaters 510 is not limited as long as the gas flow within the passage 135 is not inhibited.

In gas turbine systems, late lean injection (LLI) is used to increase efficiency of the gas turbine and to reduce environmental emissions. Efficiency of gas turbines can be increased by increasing the temperature at which the fuel is burned. However, one drawback of high temperature fuel burning is that the formation of NOx pollutants can increase. This can be counteracted by controlling flame within various zones of combustor, and by reducing the residence time of reactants at the high temperature.

Generally, LLI systems include at least two fuel supply stages in the combustor. At the head end of the combustor, the fuel is supplied and ignited to sustain a flame within the combustor. At the LLI stage further downstream in the combustor and before the turbine, more fuel is injected. At this stage, the temperature can be quite high. For example, exit temperature may be as high as 2500° F. However, since the fuel is injected at a very late stage, the residence time is reduced which in turn reduces the amount of NOx formation.

Unfortunately, there is also correspondingly increased stresses—thermal and pressure—that accompany the LLI system. These stresses make fuel leaks potentially hazardous. Due to the increased temperature and pressure, risk of explosion due to any fuel leak is correspondingly magnified. Thus, being able to detect fuel leaks in LLI systems would be particularly advantageous.

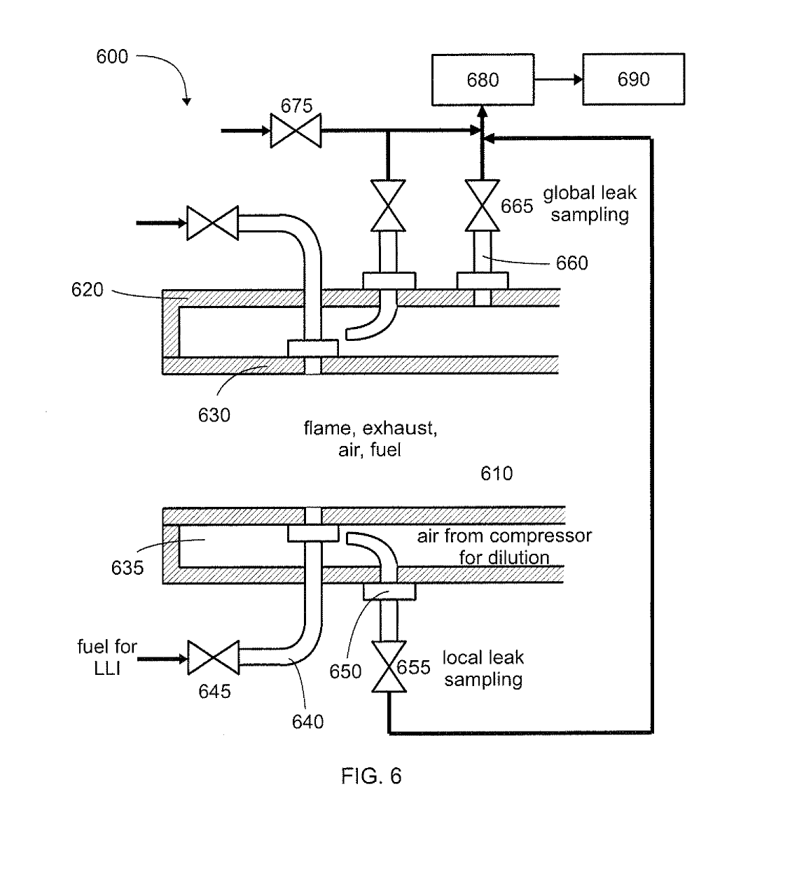

FIG. 6 illustrates a system 600 for detecting leakage in a late lean injection arrangement according to a non-limiting aspect of the present invention. The arrangement illustrated in FIG. 6 is only a partial view of a complete gas turbine assembly. Parts such as the head end, the fuel mixing nozzles, the compressor and so on are omitted for clarity.

The system 600 includes a combustor 610 in which fuel and air mixture is combusted. Within the portion of the combustor 610 illustrated in FIG. 6, there can be a combination of flame, exhaust, air and fuel. The interior of the combustor 610 is formed by combustor transition pieces 630. An enclosure 620 surrounds the combustor 610 along at least portion thereof so as to define a dilution chamber 635 in which compressed air from a compressor is provided.

The fuel for the late lean injection into the combustor 610 is delivered by a plurality of LLI fuel pipes 640 fluidly connected to the combustor 610. The amount of fuel injected into the LLI fuel pipes 640 can be controlled through operating a plurality of LLI fuel valves 645 fluidly connected to the LLI fuel pipes 640.

The system 600 includes a plurality of local LLI sampling valves 655 whose inlets are fluidly connected to the dilution chamber 635. Preferably, the inlet of each sampling valve 655 is fluidly connected to a portion of the dilution chamber 635 substantially co-located where the corresponding LLI fuel pipe 640 fluidly connects with the combustor 610. The fluid connection with the dilution chamber 635 can be provided by a plurality of corresponding local LLI sampling pipes 650. As seen, the local LLI sampling pipes 650 can include open ends located near where the LLI fuel pipes 640 penetrates the combustor transition piece 630. The outlets of the local LLI sampling valves 655 are fluidly connected to a gas detector 680.

The gas detector 680 may perform functions similar to the gas detector 140. The gas detector 680 may be a gas analyzer, a spectrometer, a LEL sensor, or any combination thereof. Since the risk of explosion is a particular threat, it is preferred that the gas detector 680 includes at least the LEL sensor. The gas detector 680 analyzes the gas received at its input and outputs signals to the controller 690, which then analyzes whether or not there is a fuel leak based on the signals from the gas detector 680. The operations of the local sampling valves 655 are preferably individually controllable by the controller 690.

The system 600 can also include a global LLI sampling valve 665. The inlet and outlet of the global LLI sampling valve 665 are fluidly connected to the dilution chamber 635 and to the gas detector 680, respectively. The fluid connection between the global LLI sampling valve 665 and the dilution chamber 635 can be provided through a global LLI sampling pipe 660. Preferably, the global LLI sampling pipe 660 is located such that the fluid connection of the global LLI sampling valve 665 with the dilution chamber 635 is further away from the plurality of LLI fuel pipes 640 than the fluid connections of the local LLI sampling valves 655 with the dilution chamber 635. It is also preferable that the operation of the global LLI sampling valve 665 is controllable by the controller 690. While a single global LLI sampling valve 665 is illustrated in FIG. 6, this is not a limitation. That is, there can be multiple global LLI sampling valves 665 in fluid connection with the dilution chamber 635.

Optionally, the system 600 may include a sample conditioning valve 675 whose outlet is fluidly connected to the gas detector 680 and whose operation is controllable by the controller 690. Through the sample conditioning valve 675, the controller 690 may maintain conditions within the dilution chamber 635 so as to make measurements as accurate as possible. Sample conditioning process can include controlling humidity, adjusting pressure, temperature, and flow rate of the sample, as well as adding calibration gas which may be required by some specific gas analyzers.

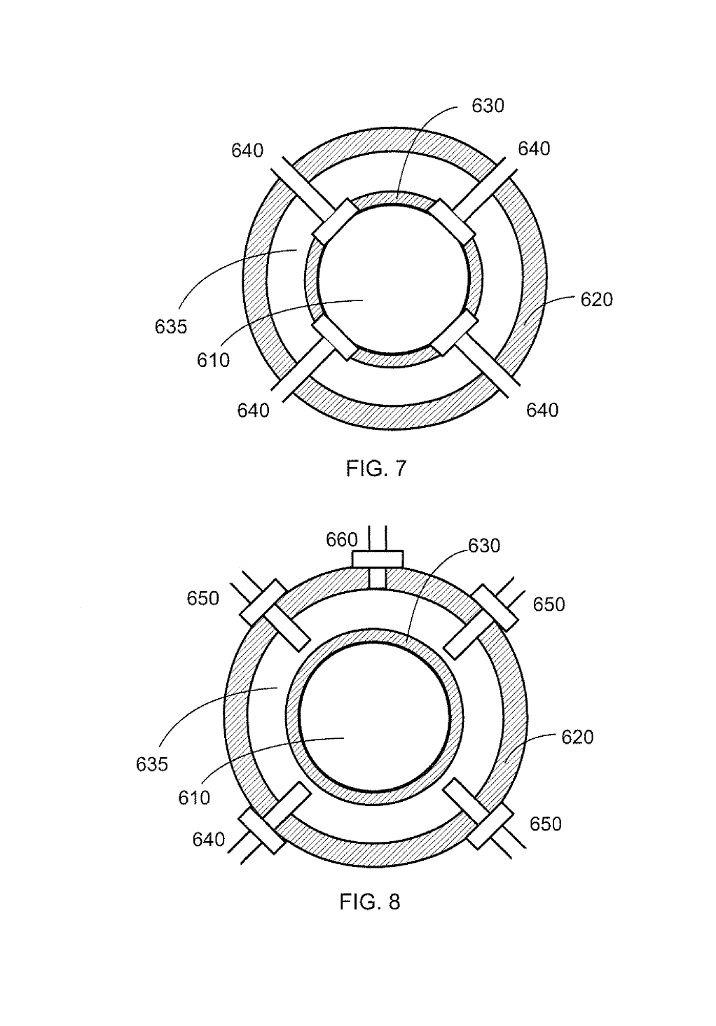

FIG. 7 illustrates an axial view of the late lean injection arrangement of FIG. 6. In particular, this is an axial view showing an example distribution of the LLI fuel pipes 640. In this example, four LLI fuel pipes 640 are distributed around the combustor 610 for late lean injection of fuel. Of course, the number of LLI fuel pipes 640 is not so limited and the distribution is also not so limited.

FIG. 8 illustrates another axial view of the late lean injection arrangement of FIG. 6. In this view, the local LLI sampling pipes 650 are shown. Note that the distribution of these local LLI sampling pipes 650 correspond to the distribution of the LLI fuel pipes 640 of FIG. 7. The view in FIG. 8 also shows an example location of the global sampling pipe 660. Again, the number and the distribution of the local LLI sampling pipes 650 and the global LLI sampling pipe 660 are not so limited.

With such an arrangement, a method of detecting a fuel leak in a late lean injection gas turbine arrangement may be as follows. The controller 690 together with the gas detector 680 can monitor the gas in the dilution chamber 635—continuously or periodically—by sampling the gas through the global LLI gas sampling valve 660. If the fuel leak is detected, then the particular LLI fuel pipe 640 that is leaking can be determined by operating the local LLI sampling valves 655 as appropriate. In another method, all local LLI sampling valves 655 may be opened for monitoring. When the leak is detected, the particular fuel pipe 640 responsible for the leak may be detected by closing a subset of the local LLI sampling valves and monitoring.

There are multiple advantages to the described embodiments of the present invention. For example, a fuel leakage in relatively long fuel piping can be detected. Also, a single detector can be utilized to detect the fuel leak and to localize the leak location. In addition, fuel leakage in late lean injection piping can be detected.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for detecting leaks in a fuel delivery arrangement, the system comprising:
a fuel pipe;
a containment cover surrounding the fuel pipe along at least a length portion of the fuel pipe so as to define a passage between an outer surface of the fuel pipe and an inner surface of the containment cover;
a plurality of sampling valves distributed in a length direction along the containment cover, wherein inlets of the sampling valves are fluidly connected to the passage;
a gas detector fluidly connected to outlets of the sampling valves and arranged to analyze gas sampled by one or more of the plurality of sampling valves; and
a controller arranged to determine whether or not there is a fuel leak based on signals from the gas detector.

2. The system of claim 1, further comprising:
a plurality of spacers distributed on the outer surface of the fuel pipe along the length portion of the fuel pipe,
wherein the containment cover is placed on the plurality of spacers along the length portion of the fuel pipe to define the passage.

3. The system of claim 1, wherein operations of the sampling valves are individually controllable by the controller.

4. The system of claim 1,
wherein the fuel pipe comprises a plurality of pipe sections joined together through one or more pipe couplers, and
wherein the inlet of at least one sampling valve is fluidly connected to a portion of the passage substantially co-located to a corresponding pipe coupler.

5. The system of claim 1, wherein the pipe couplers include weldings, flanges, connectors, and fittings.

6. The system of claim 1, wherein the gas within the passage is promoted to flow in one length wise direction.

7. The system of claim 6, wherein the inlet of at least one sampling valve is fluidly connected the passage substantially at a downstream end thereof.

8. The system of claim 6, further comprising one or more air supply valves whose outlets are fluidly connected with the passage, wherein the air supply valves are individually controllable by the controller.

9. The system of claim 8, wherein the outlet of at least one air supply valve is fluidly connected the passage upstream of all sampling valves.

10. The system of claim 8, further comprising a pressure gauge arranged to monitor gas pressure within the passage,
wherein the controller controls the air supply valves based on the pressure measured by the pressure gauge.

11. The system of claim 1, further comprising a heater arranged to heat the gas within at least a portion of the passage, wherein the heater is controllable by the controller.

12. The system of claim 1, wherein the gas detector is a gas analyzer, a spectrometer, or a lower explosion limit sensor.

13. A system for detecting leaks in a late lean injection (LLI) gas turbine arrangement, the system comprising:
a combustor in which fuel and air mixture is combusted;
an enclosure surrounding the combustor along at least portion of the combustor so as to define a dilution chamber in which compressed air from a compressor is provided for dilution;
a plurality of LLI fuel pipes fluidly connected to the combustor, wherein the plurality of LLI fuel pipes are arranged to deliver fuel to be injected into the combustor;
a plurality of local LLI sampling valves, wherein inlets of the sampling valves are each fluidly connected to a portion of the dilution chamber substantially co-located where the corresponding LLI fuel pipe fluidly connects with the combustor;
a gas detector fluidly connected to outlets of the sampling valves and arranged to analyze gas sampled by one or more of the sampling valves; and
a controller arranged to determine whether or not there is a fuel leak based on signals from the gas detector.

14. The system of claim 13, wherein operations of the local LLI sampling valves are individually controllable by the controller.

15. The system of claim 14, further comprising at least one global LLI sampling valve whose inlet is fluidly connected to the dilution chamber and whose outlet is fluidly connected to the gas detector, wherein the operation of the global LLI sampling valve is controllable by the controller.

16. The system of claim 15, wherein the fluid connection of the global LLI sampling valve with the dilution chamber is further away from the plurality of LLI fuel pipes than the fluid connections of the local LLI sampling valves with the dilution chamber.

17. The system of claim 15, further comprising a sample conditioning valve whose outlet is fluidly connected to the gas detector, wherein the operation of the sample conditioning valve is controllable by the controller.

18. The system of claim 15, further comprising a plurality of LLI fuel valves individually controllable by the controller and arranged to control the supply of the fuel to be delivered by the plurality of LLI fuel pipes.
